(19) United States
(12) Patent Application Publication
(10) Pub. No.: US 2007/0022642 A1
(43) Pub. Date: Feb. 1, 2007

(54) Gesturing inflatable doll

(75) Inventor: Sheng-Hung Hsu, Kaohsiung Hsien (TW)

Correspondence Address: COOPER & DUNHAM, LLP, 1185 AVENUE OF THE AMERICAS, NEW YORK, NY, 10036, US

(73) Assignee: Gemmy Industries Corporation

(21) Appl. No.: 11/191,879

(22) Filed: Jul. 28, 2005

(51) Int. Cl. G09F 19/08; A63H 3/06

(52) U.S. Cl. 40/419; 40/412; 446/226

(57) ABSTRACT

A gesturing inflatable doll has a body and an inflator. The body has a primary portion and a secondary portion. A membrane with vent holes is mounted between the primary portion and the secondary portion. The inflator has a first air blower to draft external air into the body, and a second air blower is provided on the membrane to pump the air from the secondary portion to the primary portion. Hence, with the alternating operation of the second air blower, the secondary portion can be lowered or raised to achieve a dynamic waving effect with the doll.

### BACKGROUND OF THE INVENTION

1. Field of the Invention

The present invention relates to a gesturing inflatable doll, and more particularly to an inflatable doll with a dynamic waving effect.

2. Description of Related Art

At present, all kinds of conventional inflatable dolls are displayed in or in front of supermarkets or department stores to attract customers and create a friendly atmosphere. A conventional inflatable decoration comprises a body made of fabric material and a barrel which has a seat formed on a lower end of the barrel. The body is mounted on the barrel so that the body is suspended above the ground. An air inlet is defined in the seat and in communication with the interior of the body and an inflator is mounted on the seat. A vent hole is defined in the inflator and corresponds to the air inlet so that air can be blown into the body when the inflator is operating. Hence, the body erects to attract the customers.

However, the conventional inflatable doll lacks dynamic movement and so soon becomes unattractive to passersby. Therefore, the invention provides a gesturing inflatable doll to mitigate or obviate the aforementioned problems.

### SUMMARY OF THE INVENTION

The main objective of the present invention is to provide a gesturing inflatable doll.

Other objectives, advantages and novel features of the invention will become more apparent from the following detailed description when taken in conjunction with the accompanying drawings.

### BRIEF DESCRIPTION OF THE DRAWINGS

FIG. 1 is a front view of an inflatable doll with an arm raised, in accordance with the present invention;

FIG. 2 is a front view of the inflatable doll with an arm lowered, in accordance with the present invention in usage; and

FIG. 3 is a front view of the inflatable doll with an arm raised again thereby completing a waving cycle, in accordance with the present invention in usage.

### DETAILED DESCRIPTION OF THE PREFERRED EMBODIMENT

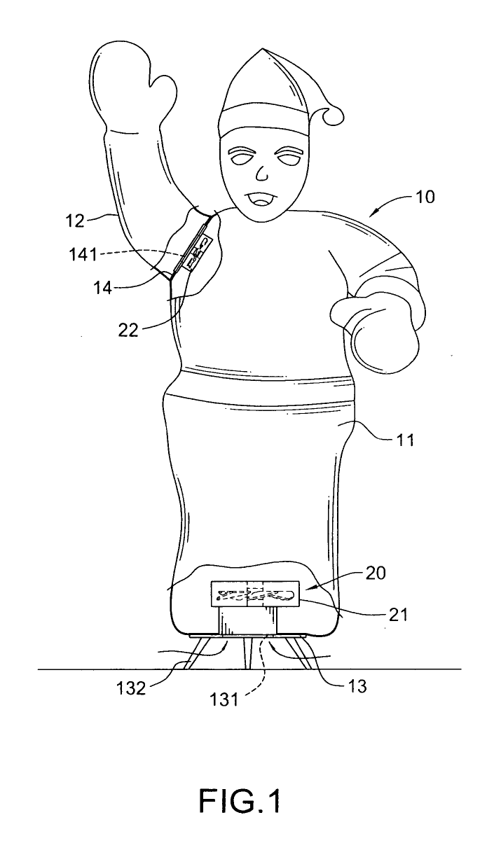

With reference to FIG. 1, a gesturing inflatable doll comprises a body (10) and an inflator (20).

The body (10) is made of fabric material which can be inflated to expand and erect to a prearranged configuration. The body (10) is composed of a primary portion (11) and at least one secondary portion (12) which is formed on the primary portion (11). In the preferred embodiment of the inflatable doll, the body (10) is like a human body and the secondary portion (12) is an arm of that human body. A base (13) is attached to a bottom end of the body (10) and at least one air inlet (131) is defined in the base (13). In the preferred embodiment of the inflatable doll,multiple feet (132) are respectively provided under the base (13) so that the at least one air inlet (131) is not blocked by the ground. A membrane (14) is mounted between the primary portion (11) and the secondary portion (12) and a vent hole (141) is defined in the membrane (14) thereby the primary portion (11) being in communication with the secondary portion (12).

The inflator (20) has a first air blower (21) and a second air blower (22), the air drafting capability of which is lower in pressure than that of the first air blower (21). The first air blower (21) is mounted on the base (13) and in the preferred embodiment of the inflatable doll, the first air blower (21) is in an interior of the body (10). At least one air outlet of the first air blower (21) communicates with the at least one air inlet (131) so that external air can be blown into the body (10). The second air blower (22) is mounted on the membrane (14) and at least one second air outlet of the second air blower (22) faces the vent hole (141) so that the air in the secondary portion (12) can be directed to the primary portion (11). In the preferred embodiment of the inflatable doll, the second air blower (22) is mounted adjacent to the primary portion (11).

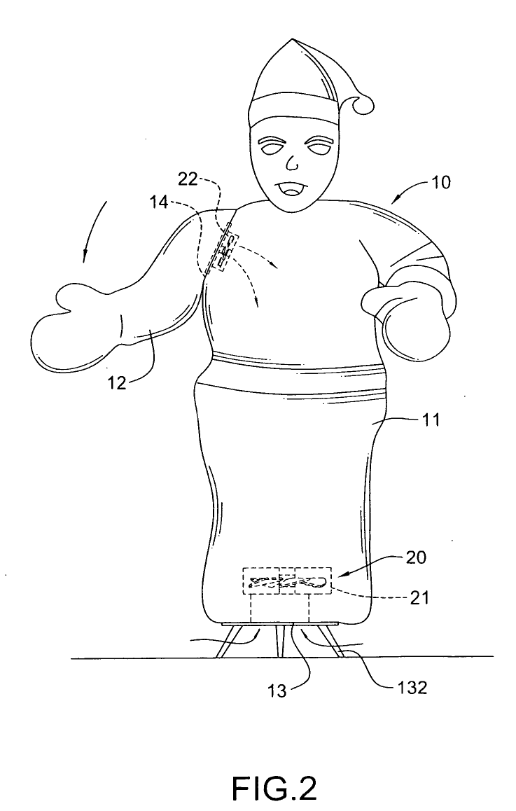

With reference to FIG. 2, the external air is drafted into the primary portion (11) and the secondary portion (12) so that the primary portion (11) expands to erect and the secondary portion (12) is raised when the first air blower (21) is operating.

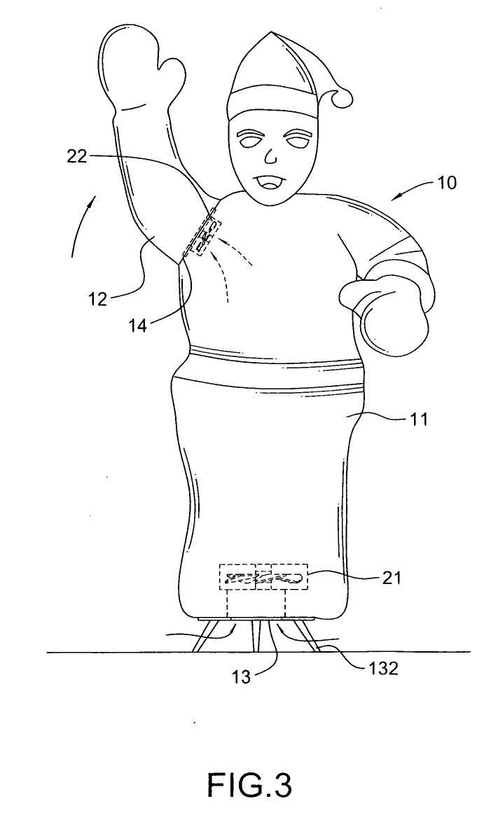

With further reference to FIG. 3, when the second air blower (22) operate and the first air blower (21) continues operating, the air in the secondary portion (12) is pumped into the primary portion (11) by the second air blower (22) so that the air in the secondary portion (12) decreases and the secondary portion (12) is lowered due to its weight. Furthermore, the second air blower (22) is stopped and the air drafted by the first air blower (21) inflates and raises the secondary portion (12) again. With the alternative operation of the second air blower (22), the inflatable doll has a dynamic effect to increase the attractiveness. That is, the figure seems to be waving to passersby and this is particularly eye-catching and welcoming.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A gesturing inflatable doll comprising:
a body (10) having a primary portion (11) and at least one secondary portion (12) formed with the primary portion (11), a membrane (14) mounted between the primary portion (11) and one of the at least one secondary portion (12) and having at least one vent hole (141) defined in the membrane (14) whereby the primary portion (11) is in communication with the secondary portion (12);
a seat (13) mounted with the body (10) and having at least one air inlet (131); and
an inflator (20) having a first air blower (21) provided on the seat (13) and a second air blower (22) provided on the membrane (14), at least one first air outlet of the first air blower (21) being in communication with the at least one air inlet (131) whereby external air is forced into the body (10) when the first air blower (21) operates, at least one second air outlet of the second air blower (22) being in communication with the at least one vent hole (141) whereby while the first air blower (21) continues operating, the second air blower (22) is intermittently actuated whereby the secondary portion (12) corresponding to the membrane (14) is intermittently evacuated of air and then the second air blower (22) is accordingly de-actuated to complete a cycle.

2. The gesturing inflatable doll as claimed in claim 1, wherein the seat (13) is provided beneath the body (10) and multiple feet (132) are respectively provided under the seat (13).

3. The gesturing inflatable doll as claimed in claim 1, wherein the body (10) resembles a human body and each one of the at least one secondary portion (12) resembles a human arm.
